(19) United States
(12) Patent Application Publication
(10) Pub. No.: US 2008/0235321 A1
(43) Pub. Date: Sep. 25, 2008

(54) Distributed contents storing system, copied data acquiring method, node device, and program processed in node

(75) Inventor: Hideki Matsuo, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA-SHI (JP)

(21) Appl. No.: 12/073,343

(22) Filed: Mar. 4, 2008

(30) Foreign Application Priority Data
Mar. 22, 2007 (JP) 2007-75031

(51) Int. Cl. G06F 15/16

(52) U.S. Cl. 709/201

(57) ABSTRACT

A node device in a distributed content storing system which includes a plurality of node devices, enabled to mutually communicate through a network, wherein the plurality of node devices has replica data of a plurality of content data different in their substance distributed and stored therein, wherein locations of the replica data thus distributed and stored are managed with respect to every content data, the node device including:
a replica number acquisition device for acquiring replica number information indicative of number of the replica data to be acquired by own node device, from a device managing locations of the replica data through the network;
a replica number comparison device for comparing the numbers of the replica data; and
a replica data acquisition device for acquiring and storing replica data by giving priority to the content data having a smaller number of replica data thus compared, from another node device.

The entire disclosures of Japanese Patent Application No. 2007-075031 filed on Mar. 22, 2007 including the specification, claims, drawings and summary are incorporated herein by reference in its entirety.

### BACKGROUND OF THE INVENTION

1. Field of the Invention

The present invention relates to a technical field of peer to peer (P2P) type communication system including a plurality of node devices mutually communicable through a network.

2. Discussion of the Related Art

As this kind of peer to peer type communication system, there is known a distributed content storing system where a replica (copied data) of content data is distributed and located (distribution storing) into a plurality of node devices. By using this system, fault tolerance and property of distributing accesses are enhanced. Location of the replica of content data thus distributed and stored can be efficiently searched for by use of a distributed hash table (hereinafter referred to as “DHT”) as shown in Japanese Unexamined Patent Publication No. 2006-197400. The DHT is memorized in each node device, and node information indicating a plurality of node devices to be transfer destinations of various types of messages (for example, including IP addresses and port numbers) are registered in the DHT.

Then, in a case where a node device participating in a distributed content storing system requests acquisition of desired content data, message (query) for searching for (finding) location of a replica of the content data is transmitted to another node device. The message is transferred by a relay node device to a node device which manages location of the replica of the content data in accordance with the DHT and finally information indicating the location is acquired from the node device which manages the location of the replica of content data. Thus, the node device which has transmitted the message requests the replica of the content data thus searched to a node device storing the replica of the content data and can receive the replica of the content data.

### SUMMARY OF THE INVENTION

Meanwhile, there are a variety of content data (different in content) capable of acquiring in the distributed content storing system. However, with regard to the content data having small number of replicas distributed and stored (small number of node devices storing the replicas), even in a case where a message (query) for searching for (finding) location of the replica is sent to another node device, response (including information indicative of the above-mentioned location) can not be promptly obtained from the node device which manages location (for example, response requires much time or does not return) in some cases. In other case, even in a case where the response is obtained, the replica can not be promptly acquired due to busy accesses to the node device storing the replica. Although the node device can acquire the replica by accessing to the content management server which manages all content data in such case, there is still a problem that load of the content management server increases.

Further, in a case where replicas of content data are newly acquired and stored in the respective node devices, because a storage capacity of the storage device (e.g. hard disk) for storing the content data replicas in respective node devices is limited, the replicas of the content data which have been previously stored are overwritten and stored, and number of the replicas further decrease in the distributed content storing system. Therefore, it is concerned that the above-mentioned problem becomes increasingly prominent.

The present invention has been made in consideration of the above problems, and the object of the present invention is to provide a distributed content storing system, a replica data acquisition method, a node device, and a node process program which enable the respective node devices to promptly acquire replicas (copied data) of the content data in the distributed content storing system.

In order to solve the problem, according to a first aspect of the present invention, there is provided node device in a distributed content storing system which includes a plurality of node devices, enabled to mutually communicate through a network, wherein the plurality of node devices has replica data of a plurality of content data different in their substance distributed and stored therein, wherein locations of the replica data thus distributed and stored are managed with respect to every content data, the node device comprising:

a replica number acquisition means for acquiring replica number information indicative of number of the replica data to be acquired by own node device, from a device managing locations of the replica data through the network, with respect to each of the plurality of content data different in their substance;

a replica number comparison means for comparing the numbers of the replica data, respectively indicated by the replica number information thus acquired; and

a replica data acquisition means for acquiring and storing replica data by giving priority to the content data having a smaller number of replica data thus compared, from another node device storing the replica data through the network.

According to the present invention, it is constructed such that replica number information indicative of number of the replica data is acquired from a device managing existence of the replica data from the network with respect to a plurality of content data which should be acquired by itself and have mutually different substances, numbers of the replica data not shown respectively in the replica number information thus acquired are compared, and the replica data is acquired from another node device storing the replica data and stored through the network. Therefore, it is possible to increase the replica data as many as a small number at an early stage. Accordingly, it is possible to make other node devices acquire the replica data more rapidly (easily acquirable).

According to the present invention, a node device acquires replica number information indicative of the number of the replica data to be acquired by the own from a device which manages location of the replica data through the network, with respect to each of the content data which are different in content. And the replica data numbers which are indicated in the replica number information thus respectively acquired are compared, the content datum having a small number of replica data compared is given priority, and the replica data are acquired and stored through the network from another node device storing the replica data. Thus it is possible to increase small number of replica data at early stage and therefore possible for another node device to acquire the replica data more promptly (more easily).

### BRIEF DESCRIPTION OF THE DRAWINGS

FIG. 1 is a view showing an example of connection status of respective node devices in a distributed content storing system related to the present embodiment.

FIG. 2 is a view showing an example of a routing table using DHT retained by node N2.

FIG. 3 is a schematic view showing an example of ID space of DHT.

FIG. 4 is a schematic view showing an example of flow of a content location inquiry (search) message sent from a user node in ID space of DHT.

FIG. 5 is a view showing an example of configuration of a node Nn.

FIG. 6 is a view showing an example of state where the user node acquires replica number information from respective root nodes.

FIG. 7 is a flowchart showing a main process in a control unit 11 of the node Nn.

FIG. 8(A) is a flowchart showing in detail a replica number inquiry processing in FIG. 7, and FIG. 8(B) is a flowchart showing in detail a content data acquisition processing in FIG. 7.

FIG. 9 is a flowchart showing in detail a message receipt process in FIG. 7.

### DETAILED DESCRIPTION OF THE PREFERRED EMBODIMENTS

Hereinafter, each designation of numerical reference in the drawings is typically as follows:
8: Network;
9: Overlay network;
11: Control unit;
12: Memory unit;
13: Buffer memory;
14: Decoder;
15: Image processing unit;
16: Display unit;
17: Audio processing unit;
18: Speaker;
20: Communication unit;
21: Input unit;
22: Bus;
Nn: Node; and
S: Distributed content storing system

Hereinafter, an embodiment of the present invention will be described in reference of figures. Here, the embodiment explained below is an embodiment in a case where the present invention is applied to a distributed content storing system.

[1. Configuration and the like of a Distributed Content Storing System]

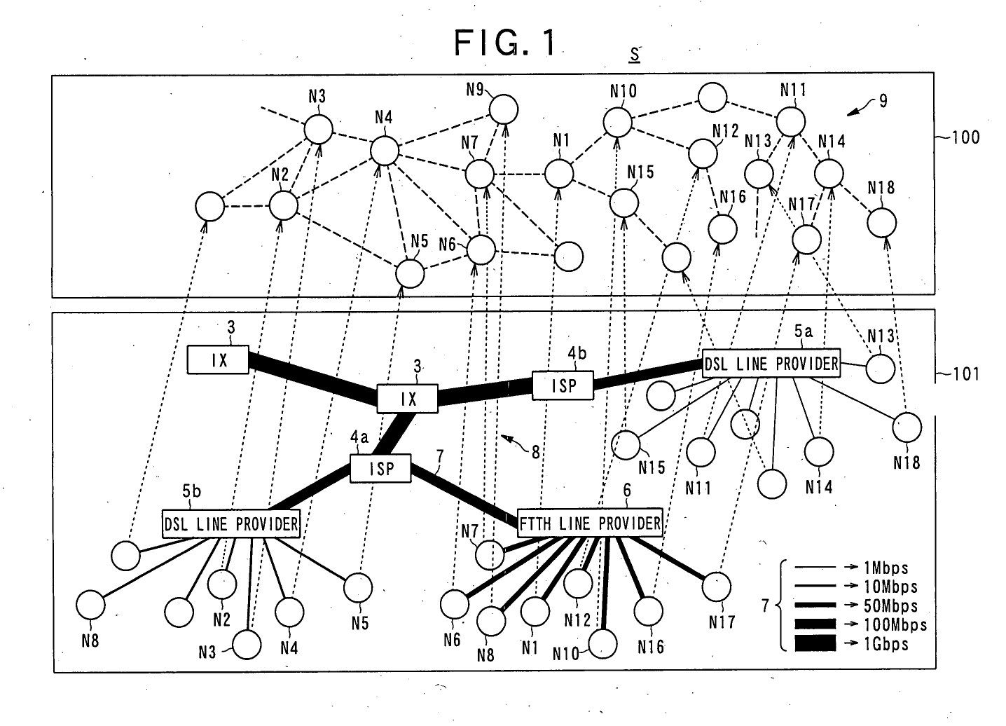

First, with reference to FIG. 1, schematic configuration and the like of a distributed content storing system according to the present embodiment will be described.

FIG. 1 is a view showing an example of connection status of respective node devices in a distributed content storing system according to the present embodiment.

As shown inside lower frame 101 of FIG. 1, a network 8 (communication network in real world and an example of communication means) of the Internet or the like is constructed by an internet exchange (IX) 3, internet service providers (ISP) 4a and 4b, digital subscriber line providers (or device thereof) (DSL) 5a and 5b, fiber to the home line provider ('s device) 6, and communication line (e.g. a phone line or an optical cable) 7, and the like. Here, in the network (a communication network) 8 of the example in FIG. 1, a router for transferring data (packet) is appropriately inserted (not shown in the figures).

In such a network 8, a plurality of node devices (hereinafter referred to as “nodes”) Nn (n=any one of 1, 2, 3 . . . ) are connected. A unique manufacturing number and an internet protocol (IP) address are assigned to each of the node Nn. Such manufacturing numbers and IP addresses do not overlap among a plurality of nodes.

Then, the distributed content storing system S according to the present embodiment is a peer to peer type network system formed by participation of any plurality of nodes Nn of these node Nn, as shown in upper frame 100 of FIG. 1. Here, a network 9 shown in upper frame 100 of FIG. 1 is an overlay network 9 (a logical network) including a virtual link formed by use of an existing network 8. Such overlay network 9 is realized by a specific algorithm, for example, an algorithm using a distributed hash table (DHT).

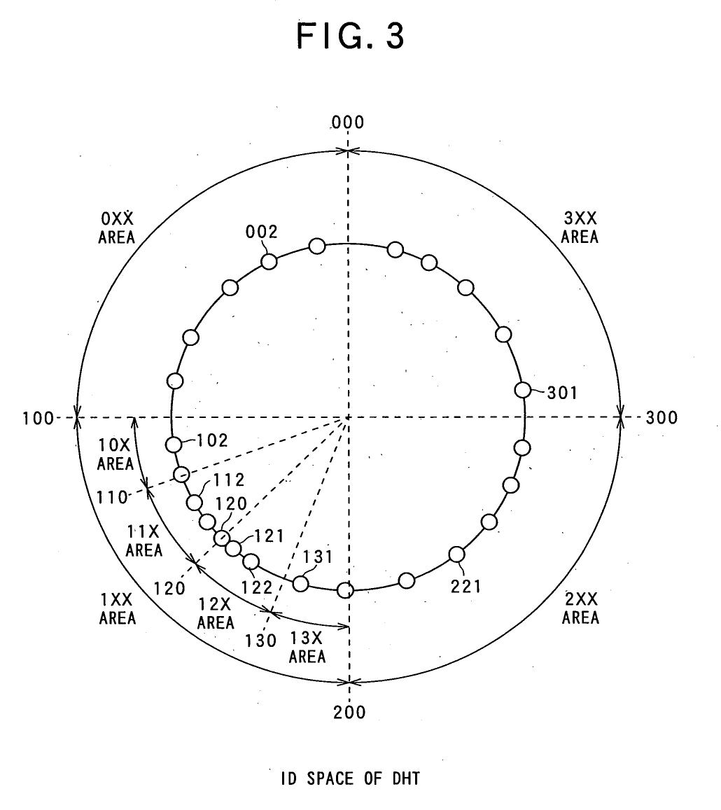

Then, each of the nodes Nn participating in the distributed content storing system S (in other words, the overlay network 9) has a node ID allocated as unique identification information as many as a predetermined number of digit. For example, the node ID is a hashed value obtained by hashing an IP address or manufacturing number (e.g. bit length is 160 bit), individually allocated to each of the nodes by a common hash function (e.g. SHA-1), whereby the nodes are distributed and located in one ID space without deviation, as shown in FIG. 3.

Participation into the distributed content storing system S is done when a non-participating node Nn (e.g. a node N8) transmits a participation message indicative of a participation request to an arbitrary node Nn already participating in the system (e.g. a contact node always participating in the system S).

As described above, the node ID obtained by a common hash function (hashed) has very low possibility of having the same value in a case where the IP address or the manufacturing number differs. It is required for these node IDs to have a bit number enough to include maximum operation number of nodes. For example, when the number is a 128-bit number, the node can manage 2̂128=340×10̂36 nodes. Since the hash function is well known, detailed explanation thereof is omitted.

Further, the nodes Nn respectively retain a routing table using DHT. The routing table regulates transfer destinations of various types of messages on the distributed content storing system S. Specifically, in the DHT, a plurality of node information including a node ID and IP address, port number, or the like of other nodes Nn, which are appropriately apart in the ID space, are registered.

One node Nn participating in the distributed content storing system S registers node information of the minimum and necessary node Nn of all the nodes Nn participating in the system S in the routing table. Delivery to a node Nn having unknown node information (not registered) is achieved such that various types of messages are transferred respectively between the nodes Nn.

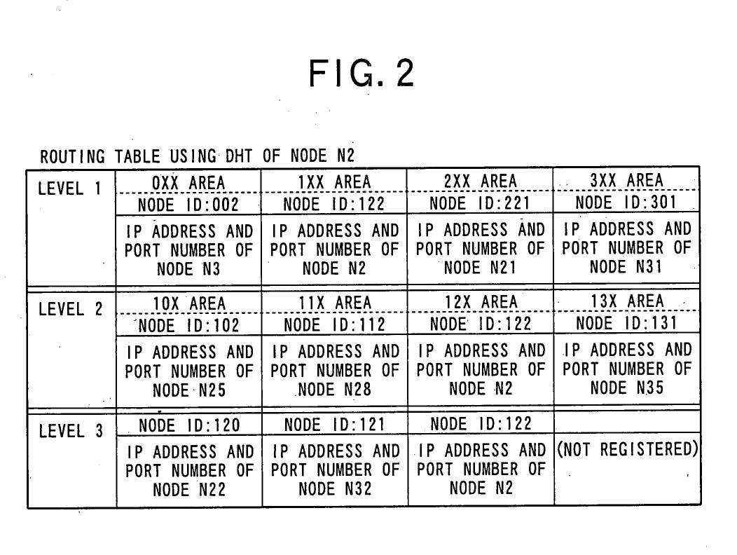

With reference to FIGS. 2 and 3, a routing table using DHT is explained in detail.

FIG. 2 is a view showing an example of a routing table of DHT retained by the node N2. FIG. 3 is a schematic view showing an example of an ID space of DHT.

In the examples of FIGS. 2 and 3, for easy of explanation, a bit length of node ID is set up to be 2 bit×3 digits=6 bit, and each of the digits is expressed by quaternary number (an integer of 0 to 3) (practically, a longer bit length is used and each digit is divided into, for example, 4 bit each and expressed by hexadecimal of 0 to f).

In the example of FIG. 2, the routing table of the DHT includes tables of levels 1 to 3 (classified into a plurality of levels). In a table entry of each level, node IDs and IP addresses and port numbers of a node Nn corresponding to the node IDs are associated and registered as node information. Each area of a table in each level is an area obtained by dividing a node ID space of DHT. For example, as shown in FIG. 3, in level 1, an entire ID space of the DHT is divided into four parts and an area where node IDs “000” to “033” exist is designated as a 0XX area, an area where node IDs “100” to “133” exist is designated as a 1XX area, an area where node IDs “200” to “233” exist is designated as a 2XX area, and an area where node IDs “300” to “333” exist is designated as a 3XX area. In level 2, areas in level 1 (that is, areas “0XX” to “3XX”) are further divided into four parts. For example, a 1XX area is divided into four parts, and an area where node IDs “100” to “103” exist is designated as a 10X area, an area where node IDs “110” to “113” exist is designated as a 11X area, an area where node IDs “120” to “123” exist is designated as a 12X area, and an area where node IDs “130” to “133” exist is designated as a 13X area.

For example, provided that anode ID of node N2 is “122”, as shown in FIG. 2, in a table of the node N2 in the 1XX area (where the own node N2 exists) of level 1, a node ID, an IP address and the like of the own node ID (because IP address belongs to the own node, registration on the IP address in the routing table is not required) are registered, and in areas where the own node N2 does not exist (in other words, 0XX, 2XX, and 3XX areas), node IDs, IP addresses and the like of other arbitrary nodes Nn are respectively registered.

Further, in the table of the node N2 in the 12X area (an area where the own node N2 exists) in level 2, as shown in FIG. 2, node ID and IP address of the own node N2 (because IP address belongs to the own node N2, registration of the IP address in the routing table is not required) are registered and in area where the own node does not exist (in other words, 10X, 11X, and 13X areas), node IDs, IP addresses and the like of other arbitrary nodes Nn are registered.

Further, in level 3 of the node N2, node IDs which are between “120” and “122”, IP addresses and the like (because IP address belongs to the own node N2, registration of the IP address in the routing table is not registered) are registered, as shown in FIG. 2.

In the examples of FIGS. 2 and 3, since bit length of a node ID is set up to be three digits×2 bit, a table having three levels can cover everything. However, when bit length of a node ID is increased, more table is required for the increased amount (for example, in a case where bit length of a node ID is set up to be 16 digits×4 bit, a table for 16 levels is required).

Thus, in a routing table of DHT according to the present embodiment, the higher the level becomes, the narrower the area becomes.

Such DHT is given when a non-participant node participates in the distributed content storing system S.

Meanwhile, copied data (hereinafter referred to as “replica”) of each of various content data (for example, movie and music) are distributed and saved (stored) in a plurality of nodes Nn in the distributed content storing system S.

For example, a replica of content data of a movie having a title of XXX is stored in nodes N1 and N5. Meanwhile, a replica of content data of a movie having a title of YYY is stored in a node N3. In such a manner, replicas of content data are distributed in a plurality of nodes Nn (hereinafter referred to as a “content retention node”) to be stored.

Further, to each of these replicas of content data, information such as a content name (title) and a content ID (identification information unique to each content) are added. The content ID is generated by, for example, hashing content name+arbitrary numerical value (or upper some bytes of the content data) by the hash function commonly used to obtain the node ID (allocated in the same ID space as the node ID). Alternatively, a system operator may give a unique ID value (same bit length as a node ID). In this case, content catalog information describing association between a content name and a content ID is distributed to all the nodes Nn.

Further, location of a content data replica thus distributed and stored, that is, index information including a group of IP address and the like of a node Nn storing the content data replica and content ID and the like corresponding to the content data are memorized (memorized in index cache) and managed by a node Nn which manages location of the content data replica (hereinafter referred to as a “root node” or “root node of content (content ID)”).

For example, index information regarding a content data replica of a movie having a title of XXX is managed by a node N4, being a root node of the content (content ID) and index information regarding a content data replica of a movie having a title of YYY, is managed by a node N6 being a root node of the content (content ID) (i.e. location of a replica is managed for each content data).

In other words, because root nodes are divided with respect to each content, load can be distributed. Moreover, even in a case where replicas of one same (same content) content data (same content ID) are stored in a plurality of content retention nodes, index information of such the content data can be managed by one root node. Therefore, each root node recognizes a number of content data replicas and location of the replicas is managed by the own root node in the distributed content storing system S (in other words, number of content retention nodes storing the replica).

Further, such a root node is determined to be a node Nn having a node ID closest to, for example, a content ID (e.g. upper digits match as many as possible).

In a case where a user of a node Nn wishes to acquire the desired content data, the node Nn wishing to acquire the content data (hereinafter referred to as “user node”) generates a content location inquiry (search) message (query) including a content ID of content data selected by the user (e.g. selected from content catalog information delivered to all nodes Nn, (wherein a content name, a content ID and the like are described and managed by, for example, a content catalog management server (not shown)) and transmits the message to another node Nn according to a routing table using DHT of the own node. That is, the user node transmits a content location inquiry (search) message to a root node (bound for the root node). Thus the content location inquiry (search) message finally reaches the root node by DHT routing using a content ID as a key.

Meanwhile, a content ID included in the content location inquiry (search) message may be generated by hashing a content name with the common hash function using the user node.

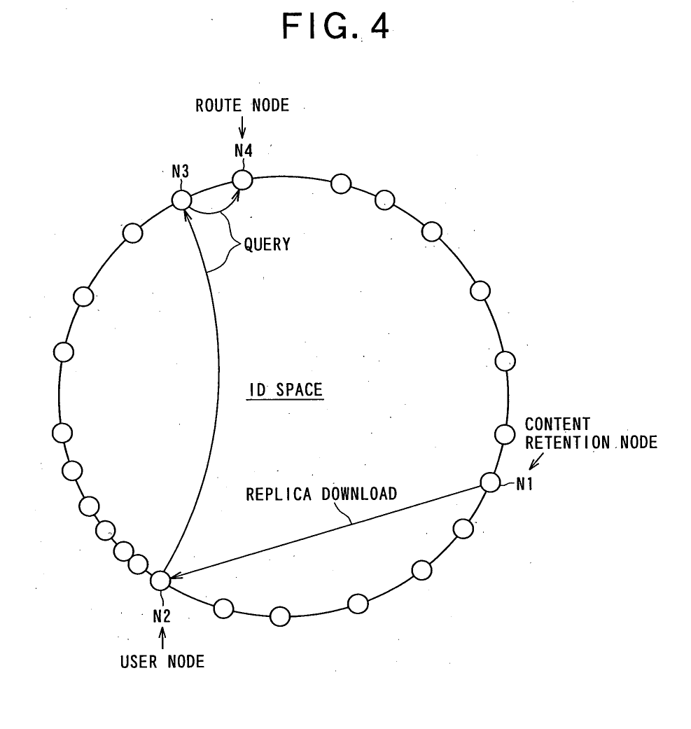

FIG. 4 is a schematic view showing an example of a flow of content location inquiry (search) message transmitted from the user node in an ID space of DHT.

In the example of FIG. 4, for example, the node N2 being a user node refers to a table of level 1 of the own DHT, acquires an IP address and a port number of, for example, a node N3 having a node ID closest to a content ID included in the content location inquiry (search) message (e.g. upper digits match the most), and transmits the content location inquiry (search) message (query) to the IP address and the port number.

Meanwhile, the node N3 receives the content location inquiry (search) message, refers to a table of level 2 of the own DHT, acquires an IP address and a port number of, for example, a node N4 having node ID closest to a content ID included in the content location inquiry (search) message (e.g. upper digits match the most), and transfers the content location inquiry (search) message to the IP address and the port number.

On the contrary thereto, the node N4 receives the content location inquiry (search) message, refers to a table of level 3 of the own DHT, and recognizes that a node having a node ID closest (e.g. upper digits match the most) to the content ID included in the content location inquiry (search) message is the node N4 itself. In other words, the node N4 recognizes that a root node of the content ID is the node N4 itself. Then the node N4 acquires index information corresponding to the content ID included in the content location inquiry (search) message from an index cache and replies the index information-to the user node transmitting the content location inquiry (search) message. Thus, the user node can transmit a content transmission request message (request information indicative of request for transmitting content data) to the content retention node, for example a node N1, storing a desired content data replica and receive a content data replica.

Alternatively, the node N4, being a root node, transmits a content transmission request message (request information including an IP address or the like of a user node indicating transmission request of a content data replica to the user node) to a content retention node which is indicated by the IP address or the like included in the index information. Thus, the user node can receive a content data replica from, for example, the node N1 being the content retention node.

Here, the user node may acquire (receive) the index information from a relay node (e.g. a cache node of node N3) which caches the index information same as the root node before the content location inquiry message reaches the root node.

The user node which acquires and stores the content data replica in such manner generates a publish (registration notification) message including content ID of the content data and own IP address or the like (since the content data replica is stored, a registration message indicating a request for registration of the IP address or the like) and transmits the publish message to a root node to thereby notify the root node that the replica is stored (in other words, in order to publicize that the own user node retains the content data replica to other nodes Nn participating in the system S). Thus, the publish message reaches the root node by DHT routing using a content ID as a key in a manner similar to a content location inquiry (search) message. The root node registers index information including a group of the IP address or the like and the content ID, included in the received publish message (memorizes in index cache area). Thus, the user node newly becomes a content retention node retaining a replica of the content data.

Here, the index information including the group of IP address or the like and content ID, included in the publish message, is registered (cached) in a relay node on a transfer route to the root node.

### [2. Configuration, Function and the Like of Node Nn]

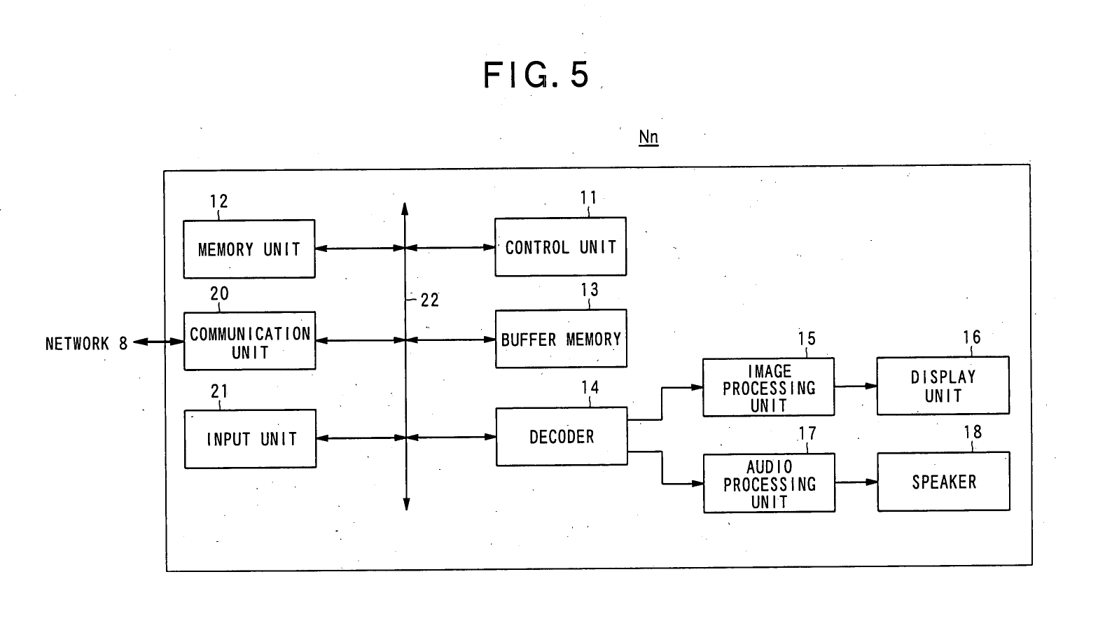

Next, with reference to FIG. 5, configuration and function of a node Nn will be explained.

FIG. 5 is a view showing a schematic configuration example of a node Nn.

Each of the node Nn is configured by including, as shown in FIG. 5: a control unit 11 being a computer configured by a CPU having computing function, a RAM for work, and a ROM for storing various data and programs; a memory unit 12 configured by an HD or the like for storing and retaining (storing) various data (e.g. a content data replica, index information, DHT), various types of programs and the like; a buffer memory 13 for temporarily storing a replica of received content data or the like; a decoder 14 for decoding (data stretch or decryption) encoded video data (image information) and audio data (voice information) included in a content data replica; an image processing unit 15 for providing a predetermined graphic process to the video data thus decoded or the like and outputting the data as video signal; a display unit 16 such as CRT and liquid crystal display for displaying image based on the video signal outputted from the image processing unit 15, or the like; an audio processing unit 17 for converting the decoded audio data in use of digital/analog (D/A) conversion into an analog audio signal, amplifying the converted signal by an amplifier and outputting the same; a speaker 18 for outputting the audio signal outputted from the audio processing unit 17 as acoustic wave; a communication unit 20 for carrying out communication control of information with respect to other node devices and servers through the network 8; and an input unit 21 (e.g. a keyboard, a mouse, or an operation panel) for receiving instruction signal from a user and providing instruction to the control unit 11, wherein the control unit 11, the memory unit 12, the buffer memory 13, the decoder 14, the communication unit 20, and the input unit 21 are connected each other through a bus 22. Here, a personal computer, a set to box (STB), and TV receiver are applicable as the nodes Nn. Moreover, in the memory unit 12, an IP address, a port number, and the like of a contact node to be an access target in participating in the distributed content storing system S are stored.

In such the configuration, when CPU in the control unit 11 reads out and executes a program in the memory unit 12 or the like, the control unit 11 totally controls, executes a process as any one of the above-mentioned user node, a relay node, a root node, a cache node, and a content retention node by participating in the distributed content storing system S. In a case where they are processed as the user node, the control unit 11 functions as replica number acquisition means, a content selection means, a replica number comparison means, and a replica data acquisition means according to the present invention.

Here, in a case where a user node acquires and stores many content data replicas (e.g. 100 pieces) from another node Nn within a limited period (e.g. within a week) in response to a content input request (storing request) from for example a system operator, the control unit 11 acquires the replica number information indicating the number of the replicas, through network NW from respective root nodes which manage location of these replicas with respect to each content data to be acquired by the own node Nn.

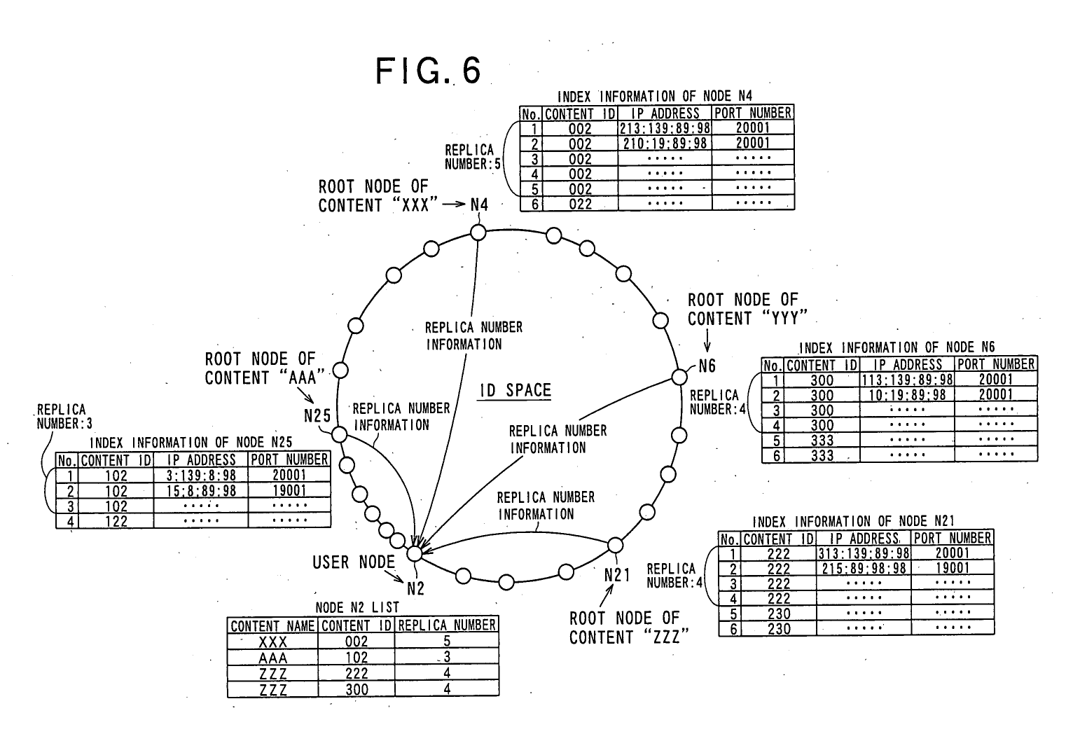

FIG. 6 is a view showing an example of a state where a user node acquires replica number information from respective root nodes.

In the example of FIG. 6, a node N2 being a user node sends a replica number inquiry message to respective root nodes, acquires replica number information from respective root nodes (node N4 being a root node of content “XXX”, node N25 being a root node of content “AAA”, node N21 being a root node of content “ZZZ”, and node N6 being a root node of content “YYY”), and registers them on the list described later. Meanwhile, for example node N4 also memorizes index information corresponding to content ID “022” as a cache node (a root node of the content ID “022” separately exists), the replica number of these content data are not included in the above-mentioned replica number information. Here, replica number inquiry message (including content ID and the own IP address) sent from the user node reaches respective root nodes by DHT routing based on content ID as a key in a manner similar to the above-mentioned content location inquiry (search) message. Further, the user node may simultaneously acquire the replica number information and the index information regarding the content data together by an inquiry message obtained by integrating the replica number inquiry message and the content location inquiry (search) message.

Then the control unit 11 compares replica numbers indicated by the respective replica number information thus acquired, acquires the replica (downloaded based on index information acquired from the root node) through the network NW from the content retention node storing the replica and stores in the memory unit 12, wherein by number of the content data with which the replicas are compared is small. In FIG. 6, for example, since the replica number of content “AAA” is the smallest, this replica is given priority and acquired first. Next replicas of contents “ZZZ” and “YYY” are acquired, and content “XXX” is acquired last.

For example, the above-mentioned node process program may be downloaded from the predetermined server on the network 8, or may be recorded in a recording medium such as CD-ROM and read through a drive for the recording medium.

[3. Action of distributed Content Storing System S]

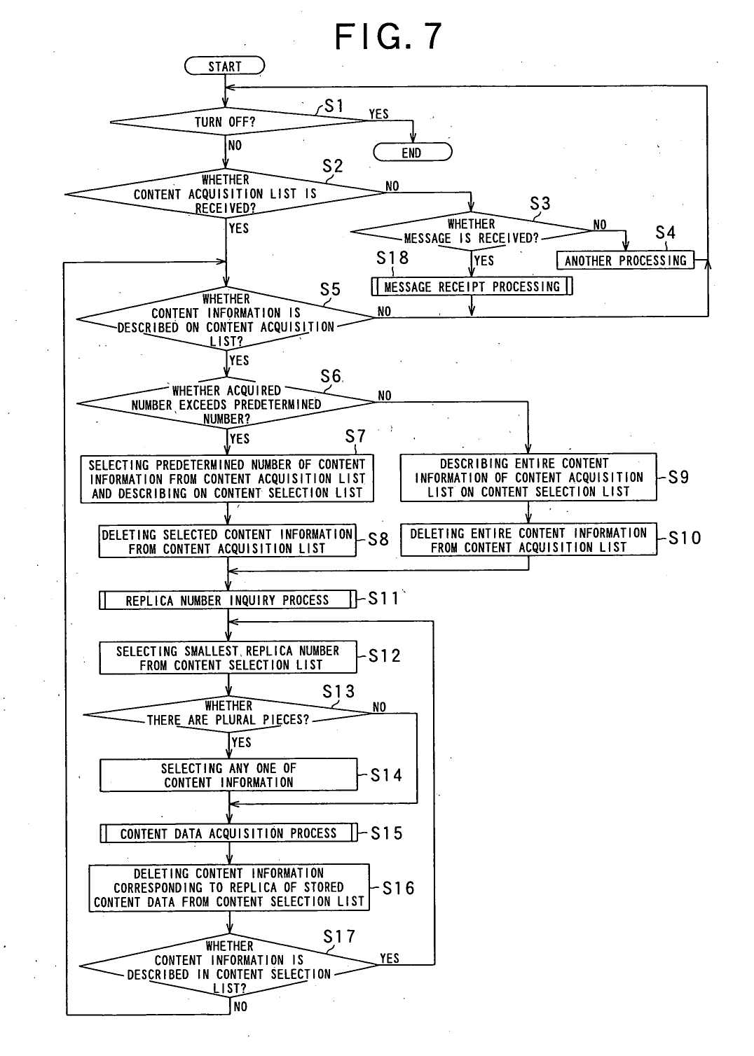

Next, an action of the distributed content storing system S will be described with reference to FIGS. 7 to 9.

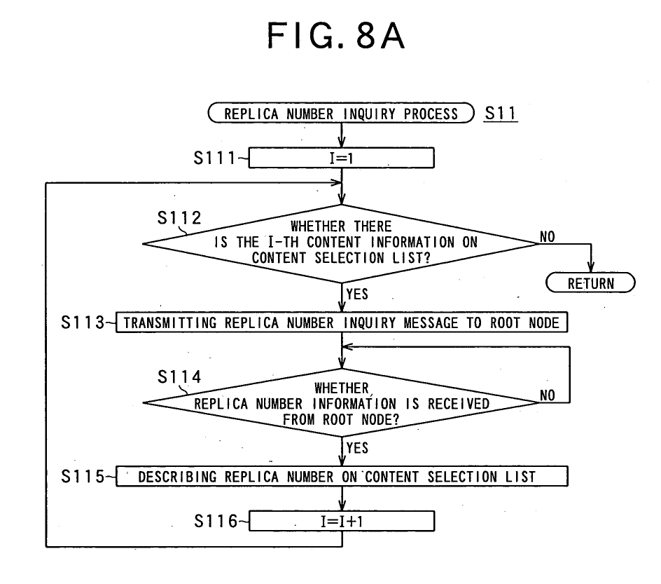

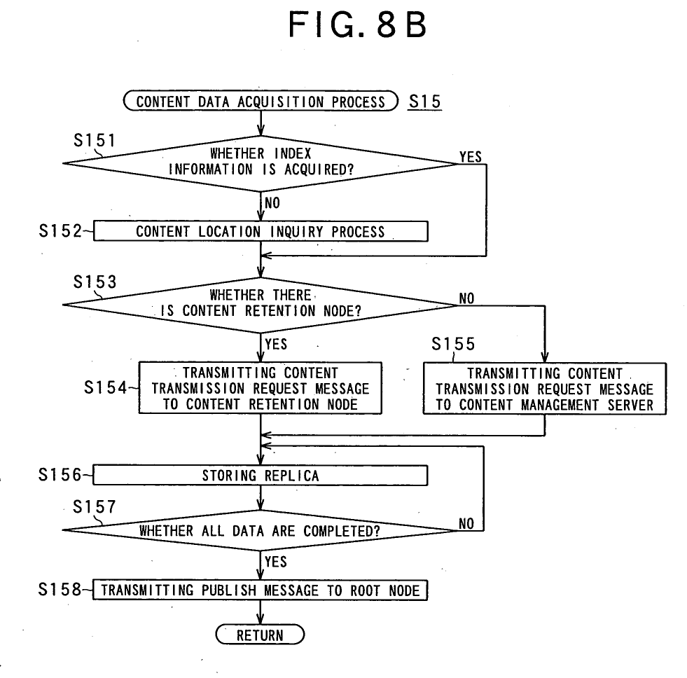

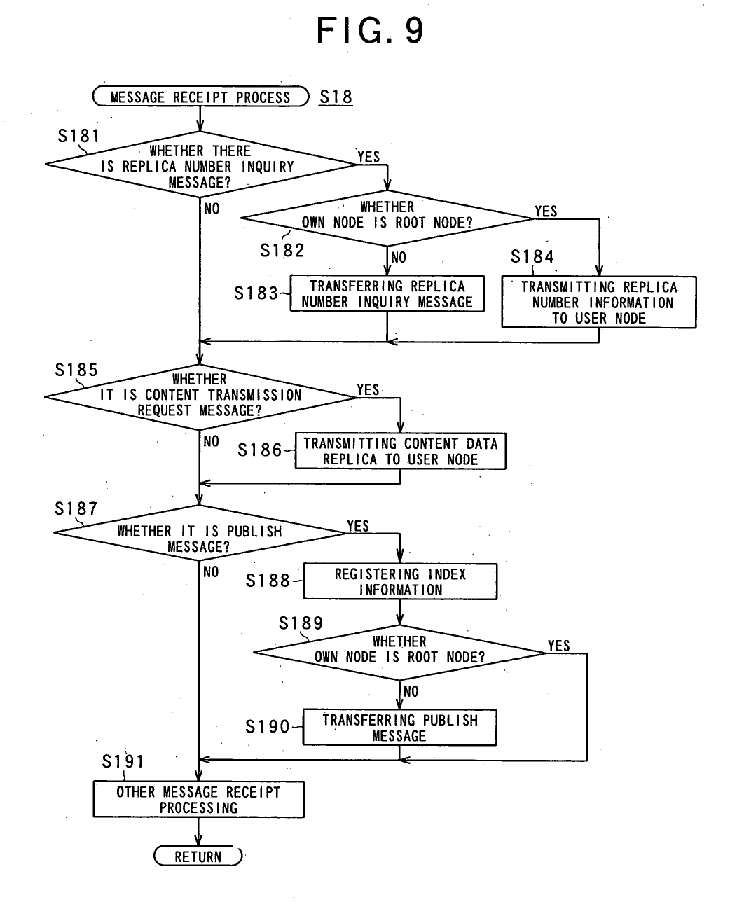

FIG. 7 is a flowchart showing main process in the control unit 11 of the node Nn. FIG. 8(A) is a flowchart showing detail of replica number inquiry process in FIG. 7, and FIG. 8(B) is a flowchart showing detail of content data acquisition process in FIG. 7. FIG. 9 is a flowchart showing detail of message receipt process in FIG. 7.

A process shown in FIG. 7 starts for example in a turned-on state in arbitrary node Nn and participation in the distributed content storing system S is carried out. In this participation process, the control unit 11 of the node Nn acquires an IP address and a port number of a contact node from the memory unit 12, connects the contact node through the network 8 based on this, and transmits a participation message (including the own node ID and node information) indicating participation request. Accordingly, a routing table is transmitted to the node Nn from another node Nn participating in the system S, the own routing table is generated based on the routing table thus received, and participation in the distributed content storing system S is completed. Detailed explanation of a method of generating a routing table is omitted because it is not directly related to the present invention. Information of IP address and the like of contact nodes is memorized in the memory unit 12 for example before shipment of the node Nn or in an initial state at the time of first installment.

Thus, upon the completion of participation in the distributed content storing system S, in a case where power-off is instructed (e.g. an operation instruction of power-off from a user through the input unit 21) (Step S1: YES), the process is finished. On the other hand, in a case where power-off is not instructed (Step S1: NO), the control unit 11 judges whether or not the content acquisition list is received (e.g. whether or not the list is received together with a content input request from a management server of such as a system operator) (Step S2). In a case where the content acquisition list is not received (Step S2: NO), the process goes to Step S3, and in a case where the content acquisition list is received (Step S2: YES), the process goes to Step S5.

On such content acquisition list, content information of respective content data (including for example content name, content ID, and data amount (e.g. several gigabyte)) is described in a prescribed order (e.g. an order of from smaller numeric values expressed by content ID, an order of “A, I, U, E, O” of content names (or by alphabet), or an order of from date of throwing into the distributed content storing system S (i.e. an order of from date of storing in the distributed content storing system S).

Further, besides the cases where the content list is acquired from a management server of such as a system operator, there is a case where the content acquisition list is made in respective nodes Nn in response to instruction by a user through the input unit. In such the cases, the user manipulates the input unit 21 to select several tens of desired content data (that desired to watch and/or listen) (e.g. selection using content name) from for example content catalog information, and to instruct to make the content acquisition list. Upon this instruction, the content information of the content data thus selected is extracted from the content catalog information, and the registered content acquisition list is made. In a case where thus prepared content acquisition list is designated by the user through the input unit 21, it is judged that the content acquisition list is received in the above-mentioned Step S2.

In Step S3, the control unit 11 judges whether or not the message transmitted from another node Nn is received. In a case where it is not received (Step S3: NO), the process goes to Step S4, and in a case where received (Step S3: YES), the process goes to Step S18 and message receipt processing is carried out.

In the other processes in Step S4, for example a process corresponding to an instruction by the user through the input unit 21 is carried out, and the process goes back to Step S1. Detailed description of the receipt process will be described later.

In Step S5, the control unit 11 judges whether or not the content information is described in the content acquisition list. In a case where it is not described (Step S5: NO), the process goes back to Step S1, and in a case where it is described (Step S5: YES), the process goes to Step S6.

In Step S6, the control unit 11 judges whether or not the number of the content information described in the content acquisition list exceeds the predetermined number (e.g. 10 pieces). In a case where it exceeds the predetermined number (Step S6: YES), the process goes to Step S7, and in a case where it does not exceed the predetermined number (Step S6: NO), the process goes to Step S9.

In Step S7, the control unit 11 selects the content data (e.g. by content name) of the above-mentioned constant number (e.g. 10 pieces) from the content acquisition list, and describes the content information in the content selection list. This is because the content data (e.g. content data to be acquired) in the content acquisition list are excerpted to obtain predetermined number and the number of replicas thereof are compared to thereby improve efficiency.

Here, the predetermined number of content data mentioned above are selected from for example the content acquisition list at random, or selected from a top of a described order (registered order) in the content acquisition list (e.g. from content “XXX” of the list in the node N2 shown in FIG. 6) (a plurality of content data having number smaller than the predetermined number are selected among a plurality of content data to be acquired by the own node Nn).

It is effective to select content data allocated with a content ID which has a small number of digits matching the predetermined digits (e.g. priority being given to matching in upper digits) of the node ID of the own node Nn (i.e. far (apart) from the own node ID in the ID space). For example, among content IDs “013”, “100”, “002”, and “221”, the content ID having the fewest matching digits with the upper digits of “001” being given priority is “221”, and on the contrary thereto a content ID having the most matching digits with the upper digits being given priority is “002”.

Therefore, in a case where the node Nn acquires and stores from the content retention node a replica of the content data corresponding to the content ID having a few matching digits with for example upper digits being given priority, since a publish message sent to the root node is transferred by more relay nodes until it reaches the root node, the index information can be stored by the more relay nodes (to be cache nodes). Therefore, efficiency in searching index information can be improved.

Next, the control unit 11 deletes the content information thus selected from the content acquisition list (Step S8), and the process proceeds to Step S11.

In Step S9, the control unit 11 describes all content information in the content acquisition list into the content selection list.

Next, the control unit 11 deletes the all content information from the content acquisition list (Step S10). Then the process goes to Step S11.

In Step S11, the control unit 11 carries out replica number inquiry processing.

In the replica number inquiry process, the control unit 11 sets up a variable number I to be “1” as shown in FIG. 8(A) (Step S111) and judges whether or not I-th content information exists in the content selection list (Step S112). In a case where I-th content information exists (Step S112: YES), the process goes to Step S113.

In Step S113, the control unit 11 transmits (send to the root node of the content ID) to the replica number inquiry message including the content ID that is included in the I-th content information to another node Nn (i.e. the node Nn having a node ID closest to the content ID (e.g. upper digits match most) according to the routing table of the own node Nn as user node. Then, the replica number inquiry message will be transferred to the root node of the content ID by DHT routing using the content ID as a key.

Next, the control unit 11 judges whether or not the replica number information which indicates replica number of the content data corresponding to the above-mentioned content ID is received from the above-mentioned root node as a reply to the above-mentioned replica number inquiry message (Step S114). In a case where the replica number information is received (Step S114: YES), replica number indicated in the replica number information is described in correspondence with the content ID in the content selection list (Step S115), the above-mentioned variable number I is incremented by “1”, and the process returns to Step S111.

Meanwhile, it may be configured such that when transmitting the replica number inquiry message in Step S113, the control unit 11 transmits a content location inquiry (search) message including a content ID included in the above-mentioned I-th content information to another node Nn (i.e. node Nn having node ID closest to the content ID (e.g. upper digits match more) (sending to a root node of the content ID) according to the own routing table. In this case, the control unit 11 receives index information corresponding to the content ID included in the above-mentioned content location inquiry (search) message.

Further, in a case where the above-mentioned replica number information is not replied within a certain period (e.g. three minutes set by a timer) after the replica number inquiry message is sent, the process proceeds to Step S115, “0” is stored as the replica number corresponding to the content ID, and then the process proceeds to Step S116.

Thus in a case where the replica number inquiry messages concerning all content information described in the content selection list are transmitted, the replica number information corresponding to the entire content data shown for example in FIG. 6 is acquired from respective root nodes, the I-th content information is judged not to exist in Step S112 (Step S112: NO). Then the process returns to the process of FIG. 7.

Next in Step S12, the control unit 11 compares replica numbers described in the above-mentioned content selection list (replica numbers indicated in the replica number information) and selects the content information, replica number compared to which is one or more and fewest, out of the content selection list.

Next, the control unit 11 judges whether or not there are plural pieces of the content information thus selected. In a case where there are the plural pieces of selected content information (i.e. a plurality of content data having the same compared replica number) (Step S13: YES), the control unit 11 selects (e.g. at random) any one of content information among them (Step S14). Then the process goes to Step S15.

Here, in a case where there are a plurality of content data same in replica number, besides randomly selecting any one of content information, it is more effective to select by priority the content data having the largest data amount (e.g. referring to the content selection list). Or in a case where the content location inquiry (search) message is transmitted and the index information corresponding to content IDs of respective content data is yet acquired (i.e. IP address and the like of the content retention node being known) in the above-mentioned Step S113, it is more effective that the content data stored in the content retention node having the longest time for data transference to the own node Nn (determination based on calculated time for transmitting data (e.g. ping) from the own node Nn to respective content retention nodes and receiving the data) is selected by priority.

In a case where content data replicas having the large data amount are downloaded from the content retention node and in a case where replicas from the content retention node requiring a long time in transmitting to the own node Nn are downloaded, long time periods for such the downloads are necessary. Therefore, such the downloads are to be carried out first.

On the other hand, in a case where there are not plural pieces of content information thus selected (one piece) (Step S13: NO), the process goes to Step S15 (while the content information being selected in Step S12).

In Step S15, the control unit 11 executes the content data acquisition process.

In the content data acquisition processing, as shown in FIG. 8(B), the control unit 11 judges whether or not index information corresponding to the content ID of the content data thus selected in the above-mentioned Step S12 or Step S14 (Step S151), and in a case where the index information is acquired, content location inquiry (search) message is transmitted for example in the above-mentioned Step S113, and the index information corresponding to the content ID of the content data is acquired (Step S151: YES). Then, the process goes to Step S153. On the other hand, in a case where the index information is not acquired (Step S151: NO), the control unit 11 carries out a content location inquiry (search) process (Step S152). Then the process goes to the Step S153. In such content location inquiry (search) process, the control unit 11 transmits the content location inquiry (search) message including content ID which is included in the content information selected in the above-mentioned Step S12 or Step S14, to another node Nn according to the own routing table, and acquires index information from a root node of the content ID.

In Step 153, the control unit 11 judges whether or not there is a content retention node storing replica of the above-mentioned selected content data (whether or not the index information can be acquired) (Step S153). In a case where there is the content retention node (Step S153: YES), the control unit 11 transmits the content transmission request message to the content retention node based on IP address and the like included in the above-mentioned acquired index information (Step S152) and receives the content data replica transmitted from the content retention node according to this. Such replicas are divided into a plurality of data units and transmitted, and the data thus received are accumulated in the buffer memory 13.

On the other hand, in a case where there is no content retention node (it can not be found for some reasons) (Step S153: NO), the control unit 11 transmits the content transmission request message to the content management server (Step S155) and accordingly receives the content data replica transmitted from the content management server. Meanwhile in a case where there is no content retention node (it can not be found), the control unit 11 may executes content location inquiry (search) process again after acquiring all the content data with their content information described in the content acquisition list, without immediately acquiring the content data from the content management server. This is because there is possibility that content retention node can be found after a lapse of time. Thus load on the content management server can be reduced. Or the content retention node corresponding to the content data which cannot be found may be acquired first from the content management server.

The content data replica transmitted from the content retention node is received though the communication unit 20 and accumulated in the buffer memory 13. Further, when the above-mentioned data of replica are accumulated in the buffer memory 13 as many as a predetermined amount, the control unit 11 causes to memorize and store the replica data from the buffer memory 13 to the memory unit 12 (e.g. writing in the predetermined area of HD) (Step S156). Thus, the replica data are sequentially sent from the buffer memory 13 to the memory unit 12 and memorized.

Next, the control unit 11 judges whether or not the all replica data are prepared and memorized (Step S157). In a case where they are not memorized and stored completely (Step S157: NO), the process returns to Step 156 and continues the process. In a case where all are memorized and stored completely (Step S157: YES), the process goes to Step S158. In a case where its replica data amount is small, it may be configured such that the data are memorized and stored in the memory unit 12 after they are all prepared in the buffer memory 13.

In Step S158, the control unit 11 transmits the above-mentioned publish message including content ID of the content data related to the stored replicas to another node Nn (i.e. node Nn having node ID closest to the content ID (e.g. upper digits match more) (to the root node of the content ID) according to the own routing table. Then the process returns to the process of FIG. 7. Thus the publish message reaches the root node by DHT rouging using content ID as a key, and the root node registers index information including a pair of IP address or the like and the content ID included in the received publish message.

Next, the control unit 11 deletes the content information corresponding to the replica of the content data which are acquired and stored from the content selection list (Step S16), and judges whether or not the content information is still described in the content selection list (Step S17). In a case where it is not described (Step S17: NO), the process returns to Step S5 and is carried out in a manner similar to the above. On the other hand, in a case where the content information is described in the content selection list (Step S17: YES), the process returns to Step S12 and is carried out in a manner similar to the above.

Here, it may be configured in such a manner that in a case where the content information is described in the content selection list (Step S17: YES), the control unit 11 returns to Step S11 instead of Step S12, again carries out the replica number inquiry process to again acquires, from respective root nodes, the replica number information indicative of replica number of content data having content information described in the content selection list. In this configuration, whenever replicas are acquired and stored by the content data acquisition process of Step S15, replica number information indicative of the number of replicas (the latest replica number) except for the replicas is reacquired, and thus reacquired replica numbers described in the content selection list are compared. Thus it takes much time (e.g. several tens of minutes) to download in accordance with content data acquisition process for example because of large replica data amount. Even in a case where a replica number to be acquired next changes, comparison and judgment can be executed using an accurate replica number numbers in the above-mentioned Step S12.

Further, in a case where content information is described in the content selection list (Step S17: YES), the control unit 11 judges whether or not the predetermined time passes from the replica number inquiry processing for example in the above Step S11. It may be configured such that the process returns to Step S12 in a case where the predetermined time doses not pass, and the control unit 11 returns to Step S11 to again carry out replica number inquiry process in a case where the predetermined time passes. Since in a case where the predetermined time does not pass, replica number of the content data to be acquired next does not change so much, replica number inquiry process is not again carried out thereby reducing burden on the network and the node.

Next, in the message receipt process in the above Step S18, the control unit 11 judges whether or not the received message is the replica number inquiry message, as shown in FIG. 9 (Step S181). In a case where it is not the replica number inquiry message (Step S181: NO), the process goes to Step S185. On the other hand, in a case where it is the replica number inquiry message (Step S181: YES), the control unit 11 judges whether or not the own node Nn is a root node (i.e. judging whether or not the own node is a node ID closest to the content ID included in the replica number inquiry message with reference to the own routing table) (Step S182). In a case where the own node is not a root node (i.e. a relay node) (Step S182: NO), the process goes to Step S183, and in a case where the own node is a root node (Step S182: YES), the process goes to Step S184.

In Step S183, the control unit 11 transfers the received replica number inquiry message to the other node Nn (i.e. node Nn having a node ID closest to the content ID included in the replica number inquiry message) (sending it to root node of the content ID), and proceeds to Step S185.

On the other hand, in Step S184, the control unit 11 transmits the replica number information indicative of replica number of the content data corresponding to the content ID included in the replica number inquiry message, to the user node which transmits the replica number inquiry message, and goes to Step S185.

In step S185, the control unit 11 judges whether or not the received message is a content transmission request message. In a case where it is not the content transmission request message (Step S185: NO), the process goes to S187. On the contrary, in a case where it is the content transmission request message (Step S185: YES), the control unit 11 divides the replica of the content data related to the request into predetermined data units and sequentially transmits to the user node transmitting the content transmission request message (Step S186). Then the process goes to Step S187 upon completion of transmission.

In Step S187, the control unit 11 judges whether or not the received message is a publish message, and in a case where it is not the publish message (Step S187: NO), the control unit 11 proceeds to Step S191. On the other hand, in a case where it is the publish message (Step S187: YES), the control unit 11 registers index information including a pair of IP address or the like and content ID included in the received publish message (storing in the index cache area) (Step S188).

Next, the control unit 11 judges whether the own node is a root node in a manner similar to Step S182 (Step S189), and in a case where the own node is not a root node (i.e. a relay node) (Step S189: NO), the process goes to Step S190. In a case where the own node is a root node (Step S189: YES), the process goes to Step S191.

In Step S190, the control unit 11 transfers the received publish message to another node Nn (i.e. node Nn having node ID closest to the content ID included in publish message) according to the own routing table (sending to the root node of the content ID) and goes to Step S191.

In the other message receipt process in Step S191, the process in a case where the above-mentioned received message is the content location inquiry (search) message and the like is carried out. Then the process goes to that in FIG. 7.

As described above, according to the above-mentioned embodiment, the respective nodes Nn acquire replica number information indicative of the replica number with respect to each content datum in the content acquisition list to be acquired by the own node from the respective root nodes, which manage location of these replicas through the network NW. The replica numbers of respective replica number information thus acquired are compared. The content data having thus compared replica numbers are acquired through the network NW and memorized and stored in a memory unit 12 while giving priority to content data having a smaller replica number. Therefore, replicas small in their number can be increased at an early stage. Accordingly, the replicas can be acquired (are easily acquired) more promptly from another node Nn. Further, burden in content management server which manages many content data can be reduced.

Further, even in a case where replicas of the content data stored past are overwritten memory because capacity of the memory unit 12 in respective nodes Nn is short, the number of content data replicas can be prevented from decreasing because the replicas are stored in many nodes Nn at an early stage.

Here, the explanation is given on a premise that the distributed content storing system S of the above-mentioned embodiment is configured by the algorithm using DHT. However, the present invention is not limited thereto.

The present invention is not confined to the configuration listed in the foregoing embodiments, but it is easily understood that the person skilled in the art can modify such configurations into various other modes, within the scope of the present invention described in the claims.

What is claimed is:

1. A node device in a distributed content storing system which includes a plurality of node devices, enabled to mutually communicate through a network, wherein the plurality of node devices has replica data of a plurality of content data different in their substance distributed and stored therein, wherein locations of the replica data thus distributed and stored are managed with respect to every content data, the node device comprising:
a replica number acquisition means for acquiring replica number information indicative of number of the replica data to be acquired by own node device, from a device managing locations of the replica data through the network, with respect to each of the plurality of content data different in their substance;
a replica number comparison means for comparing the numbers of the replica data, respectively indicated by the replica number information thus acquired; and
a replica data acquisition means for acquiring and storing replica data by giving priority to the content data having a smaller number of replica data thus compared, from another node device storing the replica data through the network.

2. The node device according to claim 1,
wherein the replica number acquisition means reacquires replica number information indicative number of replica data except for the above-mentioned replica data, from the device managing locations of the replica data, every time the above-mentioned replica data are acquired by the replica data acquisition means,
the replica number comparison means re-compares the replica data numbers respectively indicated by the replica number information, and
the replica data acquisition means acquires and the replica data from another node device storing the replica data, by giving priority to the content data having a smaller number of the replica data thus re-compared.

3. The node device according to claim 1,
wherein the replica data number acquisition means reacquires replica number information indicative of number of replica data except for the replica data acquired by the replica data acquisition means, from the device managing locations of the replica data, every time a predetermined time passes,
the replica number comparison means re-compares the replica data numbers respectively indicated by the replica number information thus acquired, and
the replica data acquisition means acquires and stores replica data from another node devices storing the replica data by giving priority to the content data having a smaller number of the replica data thus re-compared.

4. The node device according to claims 1, further comprising:
a content selection means for selecting a plurality of content data having a number smaller than the number of the plurality of content data to be acquired by the own node device,
wherein the replica number acquisition means acquires the replica number information indicative of the replica number, with respect to each of the plurality of content data thus selected, from the device managing locations of the replica data, and the replica number comparison means compares the replica data number respectively indicated by the replica number information thus acquired.

5. The node device according to claim 4,
wherein the respective content data and the respective node devices are allocated with unique identification information including predetermined number of digits, and
the content selection means selects content data to which identification information having digits fewer by one digit than the predetermined digits of the identification information of the own node device is allocated.

6. The node device according to claims 1,
wherein, in a case where there are a plurality of content data having a number same as that of the replica data thus compared, the replica data acquisition means acquires and stores replica data from another node device storing the replica data by giving a priority to the content data having a largest amount of data among those content data.

7. The node device according to claims 1,
wherein, in a case where there are a plurality of content data having the same number of the replica data thus compared, the replica data acquisition means acquires and stores replica data from another node device storing the replica data by giving a priority to the content data stored in another node device requiring a longest time for transmitting data to the own node device.

8. A node process program causing a computer to function as a node device according to claim 1.

9. A distributed content storing system provided with a plurality of node devices enabled to mutually communicate through a network, wherein the plurality of node devices has replica data of a plurality of content data different in their substance distributed and stored therein, wherein locations of the replica data thus distributed and stored are managed every content data, the node device comprising:
a replica number acquisition means for acquiring replica number information indicative of a number of the replica data to be acquired by an own node device, from a device managing locations of the replica data through the network, with respect to each of the plurality of content data different in their substance;
a replica number comparison means for comparing the number of the replica data, respectively indicated by the replica number information thus acquired; and
a replica data acquisition means for acquiring and storing replica data by giving a priority to the content data having a smaller number of replica data thus compared, from another node device storing the replica data through the network.

10. A replica data acquisition method in a distributed content storing system including a plurality of node devices enabled to mutually communicate through a network, wherein the plurality of node devices including replica data of a plurality of content data different in content distributed and stored therein, wherein locations of replica data thus distributed and stored are managed every content data, the replica data acquisition method comprising:
a step of acquiring replica number information indicative of the number of the replica data to be acquired by an own node device, from a device managing locations of the replica data through the network, with respect to each of the plurality of content data different in their substance;
a step of comparing numbers of the replica data respectively indicated by the replica number information thus acquired; and
a step of acquiring and storing replica data from another node device storing the replica data through the network, by giving a priority to the content data having a smaller number of replica data thus compared.
